(19) United States
(12) Patent Application Publication
(10) Pub. No.: US 2026/0357720 A1
(43) Pub. Date: Nov. 12, 2026

(54) TURBOMACHINE MOUNTING APPARATUS

(71) Applicant: The University of Queensland, St. Lucia (AU)

(72) Inventors: Hugh Russell, St. Lucia (AU); Robert Frith, St. Lucia (AU)

(21) Appl. No.: 19/131,590

(22) PCT Filed: Nov. 24, 2023
(86) PCT No.: PCT/AU2023/051209

§ 371 Date: May 21, 2025

(30) Foreign Application Priority Data
Nov. 25, 2022 (AU) 2022903575

(51) Int. Cl. F01D 25/28; F01D 25/24

(52) U.S. Cl. CPC F01D 25/28; F01D 25/24; F05D 2230/60; F05D 2260/31; F05D 2260/4031

(57) ABSTRACT

Mounting apparatus for mounting a turbomachine to a mounting surface, wherein the mounting apparatus includes: a casing that encloses a rotor and a portion of a shaft of the turbomachine in use, the shaft extending in an axial direction, the casing including a plurality of lugs protruding radially from the casing; and a support arrangement including a plurality of support members that are coupled to and extend away from the mounting surface in use, each support member having a coupling end that is coupled to one of the lugs using a thermally insulated coupling in use, and each support member being offset radially from the casing between the coupling end and the mounting surface in use, such that the casing is supported relative to the mounting surface by the support arrangement while substantially preventing heat transfer from the casing to the mounting surface via the support arrangement.

### BACKGROUND OF THE INVENTION

The present invention relates to a mounting apparatus for mounting a turbomachine to a mounting surface, being particularly but not exclusively suitable for mounting an integrally geared supercritical carbon dioxide (sCO₂) turbine to a gearbox.

### DESCRIPTION OF THE PRIOR ART

Supercritical carbon dioxide may be used as a working fluid in a heat engine in a power generation system. An sCO₂ heat engine can turn heat into electricity efficiently and have rapid load-following capability. Multiple sources of heat may be utilised.

Power generation applications for sCO₂ heat engines are expected to expand in the future. In the near term, gas turbines and reciprocating engines can be used for power generation to provide rapid response, while sCO₂ heat engines can be used to recover waste energy from the exhaust streams, reducing fuel costs and carbon emissions for a given power output. In the medium term, sCO₂ heat engines may be combined with concentrated solar power, thermal batteries and other hybrid energy systems, all of which require a heat engine. In the long term, sCO₂ heat engines may be combined with small modular nuclear reactors.

The traditional method of heat recovery in power generation systems is a Steam Rankine Cycle (SRC). Compared to SRC, sCO₂ power cycles offer distinct benefits, such as smaller size, higher efficiency, more rapid response times (lower thermal inertia) and improved modulatory (thermal efficiency no reduced at smaller scale).

The relatively small size of sCO₂ heat engines coupled with relatively high operating temperatures can result in high thermal gradients in the casing and significant heat loss to adjacent structures, such as the gearbox in integrally geared implementations. This has traditionally necessitated the use of advanced materials and/or complex cooling techniques.

It would be desirable to provide improved mounting apparatus for addressing these problems or at least providing a useful alternative to existing solutions. Although these problems have been specifically encountered in the development of sCO₂ heat engines, it is expected that similar improved mounting apparatus may also be suitable for use with other types of turbomachines having relatively small size and relatively high operating temperatures, where similar problems are also encountered.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In one broad form an aspect of the present invention seeks to provide mounting apparatus for mounting a turbomachine to a mounting surface, wherein the mounting apparatus includes: a casing that encloses a rotor and a portion of a shaft of the turbomachine in use, the shaft extending in an axial direction, the casing including a plurality of lugs protruding radially from the casing; and a support arrangement including a plurality of support members that are coupled to and extend away from the mounting surface in use, each support member having a coupling end that is coupled to one of the lugs using a thermally insulated coupling in use, and each support member being offset radially from the casing between the coupling end and the mounting surface in use, such that the casing is supported relative to the mounting surface by the support arrangement while substantially preventing heat transfer from the casing to the mounting surface via the support arrangement.

In one embodiment, the support arrangement includes a collar that is coupled to the mounting surface around a first end of the casing proximate to the mounting surface in use, the plurality of support members extending from the collar, such that the support members are coupled to the mounting surface using the collar.

In one embodiment, the plurality of support members are formed integrally with the collar.

In one embodiment, the collar is a ring that surrounds the first end of the casing and is offset radially from the casing.

In one embodiment, the collar includes a plurality of fastening holes for fastening the collar to the mounting surface, the fastening holes being spaced apart evenly around the collar and separate from the support members.

In one embodiment, the support arrangement is configured to substantially prevent movement of the casing relative to the mounting surface while accommodating thermal expansion of the casing in use.

In one embodiment, each support member is configured to substantially prevent deflection in a tangential direction relative to the casing while permitting deflection in a radial direction relative to the casing, to thereby accommodate thermal expansion of the casing in use.

In one embodiment, each support member is configured to have a relatively higher stiffness in the tangential direction and a relatively lower stiffness in the radial direction.

In one embodiment, each support member includes a base portion opposing the coupling end, the base portion being relatively thicker in the tangential direction compared to a portion of the support member that extends from the base portion.

In one embodiment, an axial location of the lugs is selected so that the casing is supported to substantially eliminate axial displacement of the casing near a rotor plane of the rotor in use.

In one embodiment, the mounting surface is a vertically oriented surface and the support arrangement includes: at least two of the support members provided in a vertically opposed arrangement such that they are positioned above and below the casing in use; and at least two of the support members provided in a horizontally opposed arrangement such that they are positioned on respective sides of the casing in use.

In one embodiment, the support members are arranged in pairs, each pair of support members being fastened to one of the lugs.

In one embodiment, each pair of support members defines a gap between them for receiving the lug.

In one embodiment, the pairs of support members are spaced apart evenly around the casing.

In one embodiment, the support arrangement includes four pairs of support members.

In one embodiment, the coupling end of each support member includes an enlarged pad corresponding to the respective lug.

In one embodiment, the thermally insulated couplings between the support members and the lugs are provided by installing insulating plates between the pad of each support member and the respective lug.

In one embodiment, the lugs are formed integrally with the casing.

In one embodiment, the turbomachine is integrally geared.

In one embodiment, the turbomachine is coupled to a gearbox via the shaft, the mounting surface being a wall of the gearbox and the shaft extending from the first end of the casing through a shaft opening in the wall of the gearbox.

In one embodiment, the turbomachine includes dual opposed rotors enclosed in respective casings on opposite sides of the gearbox.

In one embodiment, each casing is supported relative to the gearbox by a respective support arrangement.

In one embodiment, the turbomachine is a supercritical carbon dioxide (sCO₂) turbine.

In one embodiment, the sCO₂ turbine is configured to operate with at least one of: a turbine inlet temperature of between 300 °C and 900 °C; a turbine inlet temperature of between 400 °C and 800 °C; and a turbine inlet temperature of approximately 700 °C.

In one embodiment, the sCO₂ turbine is configured to operate with at least one of: a turbine inlet pressure of between 10 MPa and 30 MPa; a turbine inlet pressure of between 15 MPa and 25 MPa; and a turbine inlet pressure of approximately 20 MPa.

In another broad form an aspect of the present invention seeks to provide a method for mounting a turbomachine to a mounting surface using a mounting apparatus including a casing that encloses a rotor and a portion of a shaft of the turbomachine, the casing including a plurality of lugs protruding radially from the casing, and a support arrangement including a plurality of support members each having a coupling end for coupling to one of the lugs, wherein the method includes: coupling the support arrangement to the mounting surface such that the support members extend away from the mounting surface; positioning the casing relative to the support arrangement, such that the lugs are proximate to the coupling ends of the support members, and each support members is radially offset from the casing between the coupling end and the mounting surface; and coupling the coupling end of each support member to one of the lugs using a thermally insulated coupling, such that the casing is supported relative to the mounting surface by the support arrangement while substantially preventing heat transfer from the casing to the mounting surface via the support arrangement.

In another broad form an aspect of the present invention seeks to provide mounting apparatus for mounting an integrally geared turbine, the integrally geared turbine including a rotor coupled to the gearbox via a shaft, wherein the mounting apparatus includes: a casing that encloses the rotor and a portion of a shaft of the turbine in use, the shaft extending in an axial direction through a shaft opening in a wall of the gearbox, the casing including a plurality of lugs protruding radially from the casing; and a support arrangement including a plurality of support members that are coupled to and extend away from the wall of the gearbox in use, each support member having a coupling end that is coupled to one of the lugs using a thermally insulated coupling in use, and each support member being offset radially from the casing between the coupling end and the wall of the gearbox in use, such that the casing is supported relative to the mounting surface by the support arrangement while substantially preventing heat transfer from the casing to the gearbox via the support arrangement.

In one embodiment, the support arrangement includes a collar that is coupled to the wall of the gearbox around the shaft opening and a first end of the casing proximate to the gearbox in use, the plurality of support members extending from the collar, such that the support members are coupled to the gearbox using the collar.

In one embodiment, the collar is a ring that surrounds the shaft opening and the first end of the casing and is offset radially from the casing.

In one embodiment, the integrally geared turbine is a supercritical carbon dioxide (sCO2) turbine.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1A is a perspective view of an example of mounting apparatus for mounting an sCO₂ turbine to a mounting surface;

FIG. 1B is an end view of the mounting apparatus of FIG. 1A;

FIG. 1C is a side view of the mounting apparatus of FIG. 1A;

FIG. 1D is a partial cross section view of the mounting apparatus at section A-A of FIG. 1C;

FIG. 1E is an exploded view of the mounting apparatus of FIG. 1A;

FIG. 2A is a perspective view of a support arrangement of the mounting apparatus of FIG. 1A;

FIG. 2B is a side view of the support arrangement of FIG. 2A;

FIG. 2C is an end view of the support arrangement of FIG. 2A.

FIG. 3A is a perspective view of an example of an sCO₂ turbine unit incorporating the mounting apparatus of FIG. 1A;

FIG. 3B is a partial side view of the sCO₂ turbine unit of FIG. 3A, showing one side of a gearbox and a corresponding mounting apparatus; and

FIG. 3C is a partial cross section view of the side of the gearbox and the corresponding mounting apparatus at section B-B of FIG. 3B.

### DETAILED DESCRIPTION OF THE PREFERRED EMBODIMENTS

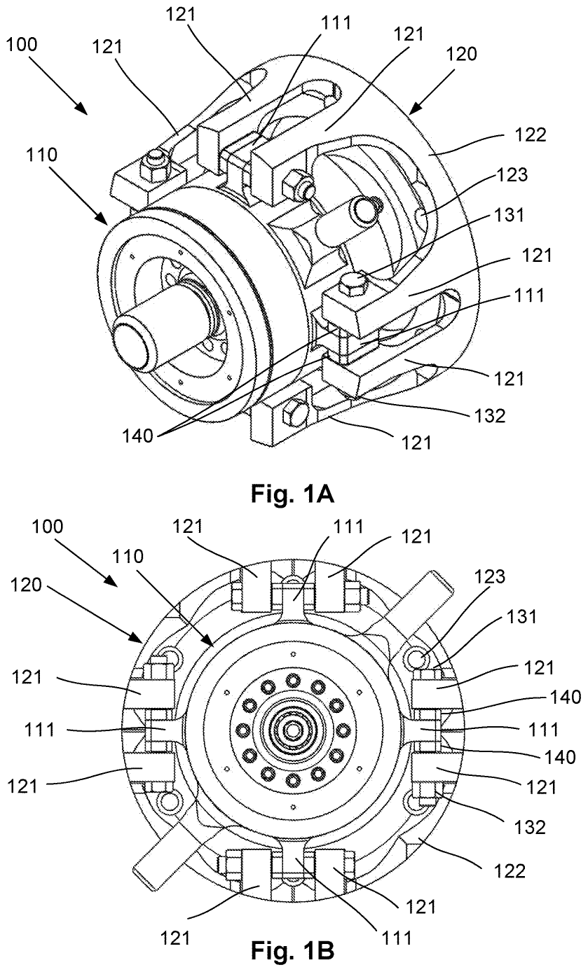

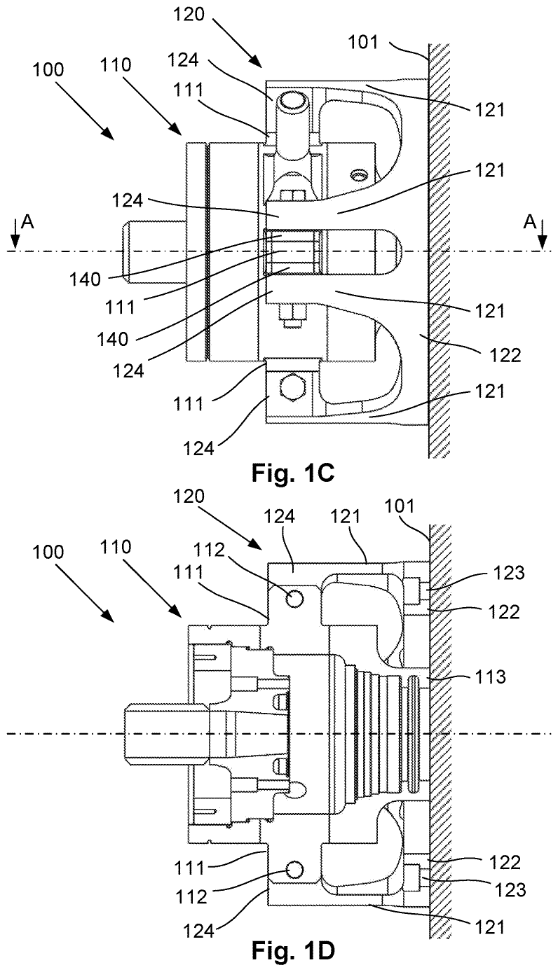

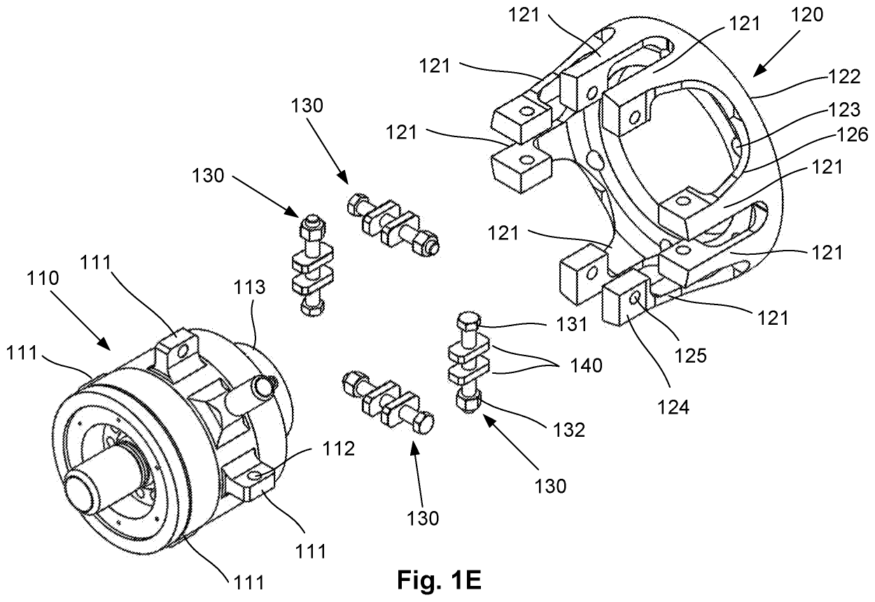

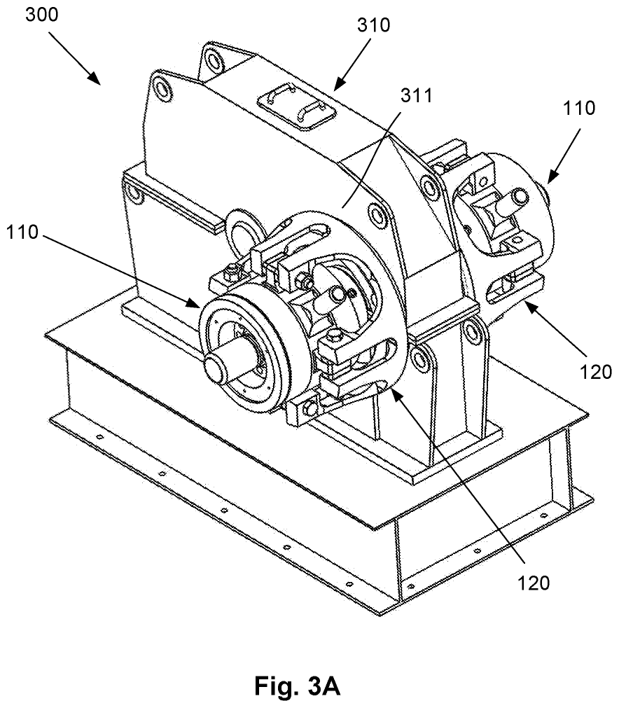

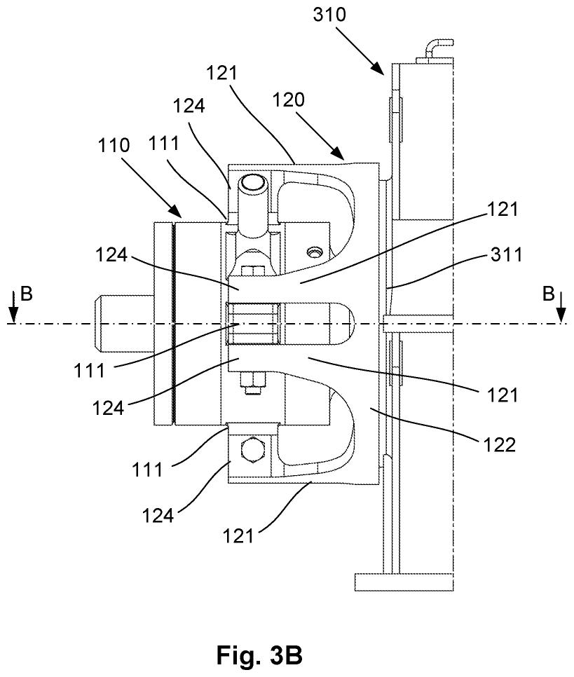

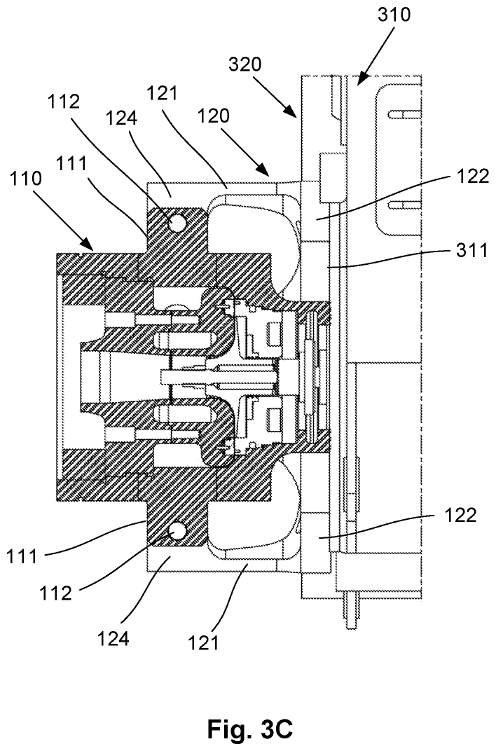

An example of a mounting apparatus 100 for mounting a turbomachine to a mounting surface 101 will now be described with reference to FIGS. 1A to 1E. In this example, the mounting apparatus 100 is designed for mounting an integrally geared sCO₂ turbine to a gearbox, for example as shown in FIGS. 3A to 3C, such that the turbomachine will be an sCO₂ turbine and the mounting surface 101 will be a wall of the gearbox. However, it should be appreciated that similar mounting apparatus 100 may be used for mounting other types of turbomachines to other types of mounting surfaces.

In broad terms, the mounting apparatus 100 includes a casing 110 that encloses a rotor and a portion of a shaft of the turbomachine in use, and a support arrangement 120 including a plurality of support members 121 that are coupled to and extend away from the mounting surface 101 in use, as can be seen in FIGS. 1C and 1D.

The shaft extends in an axial direction (with reference to the shaft axis indicated in FIGS. 1C and 1D), and the casing 110 includes a plurality of lugs 111 protruding radially from the casing 110. Each support member 121 has a coupling end that is coupled to one of the lugs 111 using a thermally insulated coupling in use, and each support member 121 is offset radially from the casing 110 between the coupling end and the mounting surface 101 in use, such that the casing 110 is supported relative to the mounting surface 101 by the support arrangement 120 while substantially preventing heat transfer from the casing 100 to the mounting surface 101 via the support arrangement 120.

It will be understood that the mounting apparatus 100 can allow for a significant reduction in heat transfer from the casing 110 to the mounting surface 101 compared to conventional turbomachine mounting arrangements which involve directly coupling a casing to the mounting surface. In the example of an integrally geared turbine, this can lead to increased efficiency due to reduced heat loss from the turbine, and can also reduce or avoid the need for cooling of the gearbox.

These benefits are a result of the use of the plurality of support members 121 that are offset from the casing 110 and the thermally insulated couplings between the support members 121 and the radially extending lugs 111. This allows for effective support of the casing 110, even though the support members 121 are essentially thermally isolated from the casing 110 such that heat transfer through the support members 121 to the mounting surface 101 is avoided.

Embodiments of the mounting apparatus 100 can also provide a range of other advantages compared to conventional mounting arrangements. A suitably configured support arrangement 120 can provide a suitably rigid support structure that can maintain concentricity while allowing for thermal expansion of the casing. Suitably positioned lugs 111 and correspondingly sized support members 121 can also substantially reduce or eliminate axial movement of the casing in the rotor plane.

Further preferred and/or optional features of the mounting arrangement 100 and elements thereof, and further advantages, will now be described with reference to the Figures.

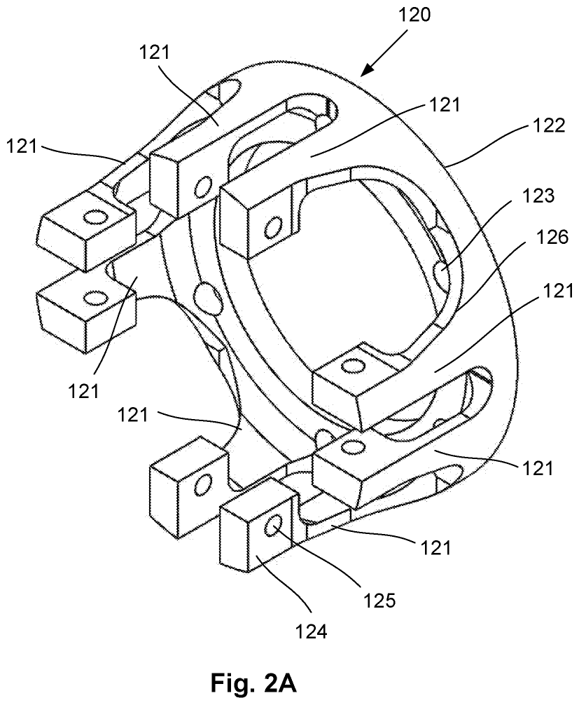

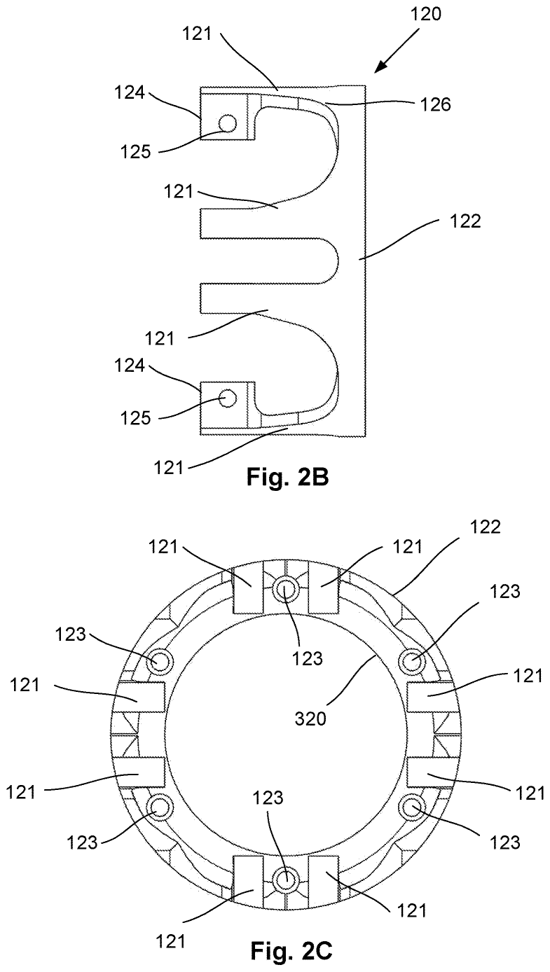

FIGS. 2A to 2C show the support arrangement 120 separately. The support arrangement 120 may include a collar 122 that is coupled to the mounting surface 101 around a first end 113 of the casing 110 proximate to the mounting surface 101 in use, as shown in FIG. 1D. The plurality of support members 121 may extend from the collar 122, such that the support members 121 are effectively coupled to the mounting surface 101 using the collar 122.

The use of a support arrangement 120 including a collar 122 in this fashion can allow for convenient coupling of the support members 121 to the mounting surface 101 without having to separately locate the support members 121 relative to the casing 110 and couple them to the mounting surface 101.

However, it should be appreciated that some examples of the support arrangement 120 may be provided without having a collar 122. For example, the support arrangement 120 a number of separate components including one or more (such as a pair) of the support members 121 which may be separately coupled to the mounting surface 101.

The plurality of support members 121 may be formed integrally with the collar 122, as in the embodiment shown in FIGS. 2A to 2C. This can allow the support members 121 and the collar 122 to be provided as a single component, thereby eliminating the need for assembly and simplifying the installation of the support arrangement 120. However, this is not essential and in some embodiments the support arrangement 120 may be provided as an assembly of multiple components, such as by having separate support members 121 that are attached to the collar 122.

As in the present example, the collar 122 may be provided in the form of a ring that surrounds the first end 113 of the casing 110 and is offset radially from the casing 110. This can ensure that the support members 121 will be offset from the casing 110, so that they are physically separate from the casing 110 between the thermally insulated couplings 130 and the mounting surface 101. Accordingly, this helps to avoid heat transfer from the casing 110 to the mounting surface via the support members 121.

To further facilitate installation of the mounting arrangement 120, the collar 122 may include a plurality of fastening holes 123 for fastening the collar 122 to the mounting surface 101. The fastening holes 123 will preferably be spaced apart evenly around the collar 122 and separate from the support members 121, to provide rigid coupling of the mounting arrangement 120 to the mountings surface 101 while allowing an installer to readily access the fastener locations.

The support arrangement 120 is preferably configured to substantially prevent movement of the casing 110 relative to the mounting surface 101, while accommodating thermal expansion of the casing 110 in use. Although this can be achieved in a variety of ways, features of the embodiment of the support arrangement 120 as shown in FIGS. 2A to 2C to facilitate this will now be discussed.

In some embodiments, each support member 121 may be configured to substantially prevent deflection in a tangential direction relative to the casing 110, while permitting deflection in a radial direction relative to the casing 110, to thereby accommodate thermal expansion of the casing 110 in use.

For example, this may be facilitated by configuring each support member 121 to have a relatively higher stiffness in the tangential direction and a relatively lower stiffness in the radial direction. As can be seen in FIGS. 2A and 2B, this may be achieved by forming each support member 121 to have a flattened cross section between its coupling end and the collar 122, which is relatively thicker in the tangential direction and relatively thinner in the radial direction.

In some embodiments, each support member 121 may include a base portion 126 opposing the coupling end, the base portion 126 being relatively thicker in the tangential direction compared to a portion of the support member 121 that extends from the base portion 126. This thickened base portion 126 can provide enhanced resistance to bending, which can provide for more rigid support of the casing 110 against loading due to gravity.

An axial location of the lugs 111 may be selected so that the casing 110 is supported to substantially prevent axial displacement of the casing 110 near a rotor plane of the rotor in use. This can improve turbine efficiency and start-up performance. For example, in some embodiments, the axial location of the lugs 111 may be substantially aligned with the rotor plane. In other embodiments, the axial location of the lugs 111 may be further away from the mounting surface 101 compared to the rotor plane.

The mounting surface 101 will typically be a vertically oriented surface as shown in FIGS. 1C and 1D. In this context, the support arrangement 120 may include at least two of the support members 121 provided in a vertically opposed arrangement such that they are positioned above and below the casing 110 in use, and at least two of the support members 121 provided in a horizontally opposed arrangement such that they are positioned on each side of the casing 110 in use.

It will be appreciated that this can provide an advantageous structural support configuration, in which the support members 121 in the horizontally opposed arrangements (i.e. on each side of the casing 110) provide improved rigidity in the vertical direction. This is enhanced when the support members 121 have relatively higher stiffness in the tangential direction and relatively lower stiffness in the radial direction as mentioned above, and yet the support arrangement 120 will allow thermal expansion to occur while maintaining concentricity and eliminating axial movement of the casing 110 in the rotor plane.

In some embodiments, the support members 121 may be arranged in pairs, where each pair of support members 121 may be fastened to one of the lugs 111, as shown in FIGS. 1A and 1B. For example, each pair of support members 121 may define a gap between them for receiving the lug 111, as can be seen in FIG. 2A. The pairs of support members may be spaced apart evenly around the casing 110.

In the particular example shown in FIGS. 1A to 1E and FIGS. 2A to 2C, the support arrangement 120 includes four pairs of support members 121. In view of the discussion above, it will be appreciated that two of these pairs of support members 121 are provided in the vertically opposed arrangement such that they are positioned above and below the casing 110 in use, and the other two of the pairs of support members 121 are provided in the horizontally opposed arrangement such that they are positioned on respective sides of the casing 110 in use.

This configuration of the support arrangement 120 including pairs of support members 121 positioned above, below and on either side of the casing 110 has been found to provide a particularly advantageous structural configuration, where the pairs on either side of the casing 110 provide rigidity in the vertical gravity loading direction, but allows thermal expansion to occur while maintaining concentricity and eliminating axial movement of the casing in the rotor plane. Nevertheless, it should be appreciated that this is not essential and that other configurations of the support arrangement 120 can be provided whilst delivering the other benefits as discussed above.

The coupling end of each support member 121 may include an enlarged pad 124 corresponding to the respective lug 111. The pad 124 may include a fastener hole 125 corresponding to a fastener hole 112 in the respective lug 111, as can be seen in FIG. 1E, to facilitate coupling using a bolted connection or the like.

The thermally insulated couplings 130 between the support members 121 and the lugs 111 may be provided by installing insulating plates 140 between the pad 124 of each support member 121 and the respective lug 111, as best seen in FIG. 1C. The thermally insulated couplings 130 and insulating plates 140 thereof can also be seen separately from the casing 110 and the support arrangement 120 in the exploded view of the FIG. 1E. In this example, the couplings 13 include a bolt 131 and a nut 132 which are used to securely fasten the pads 124 of the support members 121 to the lugs 111 with insulating plates 140 sandwiched between them to thermally insulate the coupling.

Aside from the configuration of the lugs 111, the detailed design of the casing 110 will largely be driven by strength and thermal considerations depending on the turbomachine design and operating conditions, which are outside of the scope of the present inventions.

As far as the configuration of the lugs 111 is concerned, this will typically be selected to facilitate coupling with the support members 121 of the support arrangement 120, and so the support members 121 and the lugs 111 will generally have corresponding arrangements and design features. Preferably, the lugs 111 will be formed integrally with the casing 110, although this is not essential and some embodiments may include separate lug components that are attached to the casing 110.

Otherwise, the casing 110 may be designed in accordance with standard practices for the design of a pressure vessels for a pressurized machine, for example with regard to the Australian pressure vessel code AS1200 or the ASME Boiler and Pressure Vessel Code (BPVC).

In another aspect, the present invention may also relate to a method for mounting a turbomachine to a mounting surface 101. The method uses a mounting apparatus 100 as generally as described above, including a casing 110 that encloses a rotor and a portion of a shaft of the turbomachine, and a support arrangement 120 including a plurality of support members 121. The casing 110 includes a plurality of lugs 111 protruding radially from the casing 110, and each of the support members each has a coupling end for coupling to one of the lugs 111.

In broad terms, the method would include the following steps. The first step involves coupling the support arrangement 120 to the mounting surface 101 such that the support members 121 extend away from the mounting surface 101. The next step involves positioning the casing 110 and the enclosed rotor and shaft of the turbomachine relative to the support arrangement 120, such that the lugs 111 are proximate to the coupling ends of the support members 121, and each support member 121 is radially offset from the casing 110 between the coupling end and the mounting surface 101. The final step involves coupling the coupling end of each support member 121 to one of the lugs 111 using a thermally insulated coupling, such that the casing 110 is supported relative to the mounting surface 101 by the support arrangement 120 while substantially preventing heat transfer from the casing 110 to the mounting surface 101 via the support arrangement 120.

As mentioned above, the example of the mounting apparatus 100 of FIGS. 1A to 1E, and its support arrangement as shown in FIGS. 2A to 2C, is designed for use with an integrally geared turbomachine, such as the integrally geared sCO₂ turbine as shown in FIGS. 3A to 3C.

Thus, with regard to FIGS. 3A to 3C, in implementations of the mounting arrangement 100 for integrally geared turbomachines, the turbomachine may be coupled to a gearbox 310 via the shaft, and the mounting surface 101 may be a wall 311 of the gearbox 310. The shaft may extend from the first 113 end of the casing 110 through a shaft opening in the wall 311 of the gearbox 310.

As per the example shown in FIG. 3A, the turbomachine may include dual opposed rotors enclosed in respective casings 110 on opposite sides of the gearbox 310. In this example, each casing 110 may be supported relative to the gearbox 310 by a respective support arrangement 120. However, it should be appreciated that the mounting apparatus 100 can be used in single rotor turbomachines.

In this particular embodiment, the turbomachine is a supercritical carbon dioxide (sCO₂) turbine. Whilst the specific design of the sCO₂ turbine is outside of the scope of the present invention, it is noted that the design of elements the mounting apparatus 100, and especially the casing 110, will be dependent on the design of the sCO₂ turbine and its operating parameters. Accordingly, some relevant features of sCO₂ turbines for which the mounting apparatus 100 may be suitable are discussed below.

The sCO₂ turbine may be configured to operate with a turbine inlet temperature of between 300 °C and 900 °C. In preferred examples, the sCO₂ turbine may be configured to operate with a turbine inlet temperature of between 400 °C and 800 °C. In one specific embodiment, the sCO₂ turbine may be configured to operate with a turbine inlet temperature of about 700 °C. Other embodiments of the sCO₂ turbine may be configured to operate with a turbine inlet temperature of between 650 °C and 750 °C, or between 300 °C and 800 °C, or between 300 °C and 700 °C, or between 300 °C and 600 °C, or between 400 °C and 900 °C, or between 400 °C and 700 °C, or between 400 °C and 600 °C, or between 500 °C and 900 °C, or between 500 °C and 800 °C, or between 500 °C and 700 °C, or between 500 °C and 600 °C, or between 600 °C and 900 °C, or between 600 °C and 800 °C, or between 600 °C and 700 °C, or between 700 °C and 900 °C, or between 700 °C and 800 °C.

The sCO₂ turbine may be configured to operate with a turbine inlet pressure of between 10 MPa and 30 MPa. In preferred examples, the sCO₂ turbine may be configured to operate with a turbine inlet pressure of between 15 MPa and 25 MPa. In one specific embodiment, the sCO₂ turbine may be configured to operate with a turbine inlet pressure of about 20 MPa. Other embodiments of the sCO₂ turbine may be configured to operate with a turbine inlet pressure of between 10 MPa and 25 MPa, or between 10 MPa and 20 MPa, or between 10 MPa and 15 MPa, or between 15 MPa and 30 MPa, or between 15 MPa and 20 MPa, or between 20 MPa and 30 MPa, or between 20 MPa and 25 MPa, or between 25 MPa and 30 MPa.

In view of the above, in another aspect, the present invention may relate to a mounting apparatus for mounting an integrally geared turbine, such as in the example of an integrally geared sCO₂ turbine shown in FIGS. 3A to 3C, although the turbine will not necessarily be an sCO₂ turbine. The integrally geared turbine will typically include a rotor coupled to the gearbox 310 via a shaft, with the gearbox 310 also providing structural support for mounting the turbine.

In this context, the mounting apparatus 100 includes a casing 110 that encloses the rotor and a portion of a shaft of the turbine in use, and a support arrangement 120 including a plurality of support members 121 that are coupled to and extend away from a wall 311 of the gearbox 310 in use. The shaft extends in an axial direction through a shaft opening in the wall 311 of the gearbox. The casing 110 includes a plurality of lugs 111 protruding radially from the casing 110. Each support member 121 has a coupling end that is coupled to one of the lugs 111 using a thermally insulated coupling in use, and each support member 121 is offset radially from the casing 110 between the coupling end and the wall 311 of the gearbox 310 in use, such that the casing 110 is supported relative to the gearbox 310 by the support arrangement 120 while substantially preventing heat transfer from the casing 110 to the gearbox 310 via the support arrangement 120.

As discussed previously, the support arrangement 110 may include a collar 122, and in this example, the collar 122 may be coupled to the wall 311 of the gearbox 310 around the shaft opening and a first end 113 of the casing 110 proximate to the gearbox 310 in use. Once again, the plurality of support members 121 may extend from the collar 122, such that the support members are coupled to the gearbox 310 using the collar 122 in this example. The collar 122 may again be provided in the form of a ring, and in this example this will surround the shaft opening along with the first end 113 of the casing 110, and be offset radially from the casing 110.

As mentioned above, the integrally geared turbine may be a supercritical carbon dioxide (sCO2) turbine, although this will not necessarily be the case.

In the specific example as shown in FIGS. 3A to 3C, involving a dual opposed rotor, integrally geared sCO₂ turbine, the turbine may be designed for operation at a turbine inlet temperature of about 700 °C and a turbine inlet pressure of about 20 MPa. In this context, it has been found that the use of the mounting apparatus 100 results in a reduced heat loss to the gearbox 310 by 85% (from 9 kW to 1.2 kW), leading to increased efficiency and avoiding the need for gearbox cooling. Movement of the casing 110 near the rotor is limited to 1 mm, which is reduced from 3 mm in conventional designs, which improves turbine efficiency and start-up performance.

Further details of the design and construction of this specific example will now be described to highlight other preferred features.

In this specific example, the casing 110 consists of two main components, an endplate and a casing shell. The casing shell may be decomposed into a cylindrical shell, with an integral endplate. The cylindrical shell may have two nozzles with integral attachments through which the flow enters. The endplate may have a single “nozzle”, referred to as the shaft casing, in which the thermal transition from the “hot” section adjacent to the rotor to the “cool” section proximate to the interface with the gearbox shaft occurs. This region experiences high thermal stresses and should be designed to account for this through appropriate material selection and sizing.

The endplate is considered as a flat head, with a single integral nozzle attachment through which the exhaust flow exits the casing 110. The endplate may be retained by a threaded shear ring. The casing 110 may be divided into two pressure zones, recognising that flow through the stator is required to drive pressure in the high pressure zone. The pressure in the region of the rotor back face to the shaft seal experiences a pressure consistent with the maximum static pressure at the stator exit/rotor inlet.

The casing is supported both by the support arrangement 120 (which integrally provides the support members 121 and collar 122 in this example), and by the interface with the gearbox 310, which provides concentric location. The casing 110 is attached to the support arrangement 120 by integral attachment lugs 111. The support arrangement 120 is a low-temperature component. It is bolted rigidly to the gearbox 310, and isolated thermally from the casing 110 by high-strength insulation plates 140.

During heating, the casing 110 must expand radially. During this expansion, the support members 121 deflect radially by a small amount to absorb the thermal expansion. As a single opposed pair of support members 121 deflect radially, the alternate pair, which have a higher stiffness in the tangential direction, work to keep the casing 110 aligned.

Additionally, during heating the casing 110 expands axially. Due to the central location of the support member 121 attachments to the lugs 111, the absolute movement in the axial direction in the plane of the rotor is minimised. However, the casing 110 expands axially due to thermal expansion toward the gearbox 310. This movement may be accommodated within components provided at the gearbox 310 interface.

The casing shell is designed to emphasize bulk material removal by efficient means (e.g. water-jet cutting) to limit material removal by machining. However, alternative fabrication method such as forging or casting may also be used. From stock material, three sections may be cut for the casing shell. Using a profiling technique such as water jet cutting, these rough sections are formed into the three components that make up the casing shell; the inlet section (with integral nozzle and attachment tab forms, which must be refined using limited machining); the shaft casing section; and the shear ring section, each as discussed above. After appropriate machining these sections may be welded using full-penetration circumferential welds and heat treated. After these processes are completed, machining is used to create the remaining features, such as the integral lugs 111.

The casing 110 may be designed for concentric assembly. Initially, the support arrangement 120 is installed and aligned. The casing 110 may then be inserted into position and aligned concentrically with the gearbox 310. Alignment of the casing 110 with the gearbox 310 may be achieved, for example, using matched pairs of shim plates between the insulation plates 140 and the support members 121. The remaining components of the sCO₂ turbine and casing 110 may then be aligned to the gearbox 310 and installed axially. After installation of the endplate assembly of the casing 110, an external hydraulic preloading system may be used to engage an external thread on the casing 110 and impart a preload force against the endplate assembly. This permits the shear ring to be installed with minimal torque. The preloading assembly may then be removed.

In any event, in view of the above description, it will be appreciated that the embodiments of the mounting apparatus 100 will provide an improved solution for mounting turbomachines to mounting surface, in integrally geared sCO₂ turbine implementations or in other types of turbomachines having relatively small size and relatively high operating temperatures. The use of offset support members that have thermally insulated couplings to radially protruding lugs of the casing substantially reduces heat loss to the mounting surface and can remove the need for the design of the casing and support structure to account for high thermal gradients.

The casing that contains the pressure and directs the flow through the rotor of the turbomachine may be attached to the support members in the plane of the rotor, rather than being bolted directly to the gearbox or other suitable mounting surface. The support arrangement is thermally insulated from the casing, and thus does not change temperature. Therefore the axial position of the casing and rotor will not change due to thermal expansion.

As discussed, the mounting apparatus is particularly, but not exclusively, suitable for use with integrally geared (rotor is suspended from gearbox) turbomachinery (turbines, compressors) operating at high temperatures, which may extend beyond the normal operating temperature for integrally geared turbomachines using conventional mounting arrangements. Beneficially, embodiments of the mounting apparatus can allow thermal expansion of the casing to occur while maintaining concentricity and reducing heat loss from the casing through conduction, and significantly reducing axial movement of the casing in the rotor plane.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. Mounting apparatus for mounting a turbomachine to a mounting surface, wherein the mounting apparatus includes:
a) a casing that encloses a rotor and a portion of a shaft of the turbomachine in use, the shaft extending in an axial direction, the casing including a plurality of lugs protruding radially from the casing; and
b) a support arrangement including a plurality of support members that are coupled to and extend away from the mounting surface in use, each support member having a coupling end that is coupled to one of the lugs using a thermally insulated coupling in use, and each support member being offset radially from the casing between the coupling end and the mounting surface in use, such that the casing is supported relative to the mounting surface by the support arrangement while substantially preventing heat transfer from the casing to the mounting surface via the support arrangement.

2. Mounting apparatus according to claim 1, wherein the support arrangement includes a collar that is coupled to the mounting surface around a first end of the casing proximate to the mounting surface in use, the plurality of support members extending from the collar, such that the support members are coupled to the mounting surface using the collar.

3. Mounting apparatus according to claim 2, wherein the plurality of support members are formed integrally with the collar.

4. Mounting apparatus according to claim 2, wherein the collar is a ring that surrounds the first end of the casing and is offset radially from the casing.

5. Mounting apparatus according to claim 2, wherein the collar includes a plurality of fastening holes for fastening the collar to the mounting surface, the fastening holes being spaced apart evenly around the collar and separate from the support members.

6. Mounting apparatus according to claim 1, wherein the support arrangement is configured to substantially prevent movement of the casing relative to the mounting surface while accommodating thermal expansion of the casing in use.

7. Mounting apparatus according to claim 6, wherein each support member is configured to substantially prevent deflection in a tangential direction relative to the casing while permitting deflection in a radial direction relative to the casing, to thereby accommodate thermal expansion of the casing in use.

8. Mounting apparatus according to claim 7, wherein each support member is configured to have a relatively higher stiffness in the tangential direction and a relatively lower stiffness in the radial direction.

9. Mounting apparatus according to claim 7, wherein each support member includes a base portion opposing the coupling end, the base portion being relatively thicker in the tangential direction compared to a portion of the support member that extends from the base portion.

10. Mounting apparatus according to claim 1, wherein the mounting surface is a vertically oriented surface and the support arrangement includes:
a) at least two of the support members provided in a vertically opposed arrangement such that they are positioned above and below the casing in use; and
b) at least two of the support members provided in a horizontally opposed arrangement such that they are positioned on respective sides of the casing in use.

11. Mounting apparatus according to any claim 1, wherein the support members are arranged in pairs, each pair of support members being fastened to one of the lugs.

12. Mounting apparatus according to claim 11, wherein at least one of:
a) each pair of support members defines a gap between them for receiving the lug;
b) the pairs of support members are spaced apart evenly around the casing; and
c) the support arrangement includes four pairs of support members.

13. Mounting apparatus according to claim 1, wherein at least one of:
a) the coupling end of each support member includes an enlarged pad corresponding to the respective lug;
b) the thermally insulated couplings between the support members and the lugs are provided by installing insulating plates between the pad of each support member and the respective lug;
c) the lugs are formed integrally with the casing; and
d) an axial location of the lugs is selected so that the casing is supported to substantially eliminate axial displacement of the casing near a rotor plane of the rotor in use.

14. Mounting apparatus according to claim 1, wherein the turbomachine is integrally geared.

15. Mounting apparatus according to claim 1, wherein the turbomachine is coupled to a gearbox via the shaft, the mounting surface being a wall of the gearbox and the shaft extending from the first end of the casing through a shaft opening in the wall of the gearbox.

16. Mounting apparatus according to claim 15, wherein the turbomachine includes dual opposed rotors enclosed in respective casings on opposite sides of the gearbox.

17. Mounting apparatus according to claim 16, where each casing is supported relative to the gearbox by a respective support arrangement.

18. Mounting apparatus according to claim 1, wherein the turbomachine is a supercritical carbon dioxide (sCO₂) turbine.

19. Mounting apparatus according to claim 18, wherein the sCO₂ turbine is configured to operate with at least one of:
a) a turbine inlet temperature of between 300 °C and 900 °C;
b) a turbine inlet temperature of between 400 °C and 800 °C; and
c) a turbine inlet temperature of approximately 700 °C.

20. Mounting apparatus according to claim 18, wherein the sCO₂ turbine is configured to operate with at least one of:
a) a turbine inlet pressure of between 10 MPa and 30 MPa;
b) a turbine inlet pressure of between 15 MPa and 25 MPa; and
c) a turbine inlet pressure of approximately 20 MPa.

21. A method for mounting a turbomachine to a mounting surface using a mounting apparatus including a casing that encloses a rotor and a portion of a shaft of the turbomachine, the casing including a plurality of lugs protruding radially from the casing, and a support arrangement including a plurality of support members each having a coupling end for coupling to one of the lugs, wherein the method includes:
a) coupling the support arrangement to the mounting surface such that the support members extend away from the mounting surface;
b) positioning the casing relative to the support arrangement, such that the lugs are proximate to the coupling ends of the support members, and each support members is radially offset from the casing between the coupling end and the mounting surface; and
c) coupling the coupling end of each support member to one of the lugs using a thermally insulated coupling, such that the casing is supported relative to the mounting surface by the support arrangement while substantially preventing heat transfer from the casing to the mounting surface via the support arrangement.

22. Mounting apparatus for mounting an integrally geared turbine, the integrally geared turbine including a rotor coupled to the gearbox via a shaft, wherein the mounting apparatus includes:
a) a casing that encloses the rotor and a portion of a shaft of the turbine in use, the shaft extending in an axial direction through a shaft opening in a wall of the gearbox, the casing including a plurality of lugs protruding radially from the casing; and
b) a support arrangement including a plurality of support members that are coupled to and extend away from the wall of the gearbox in use, each support member having a coupling end that is coupled to one of the lugs using a thermally insulated coupling in use, and each support member being offset radially from the casing between the coupling end and the wall of the gearbox in use, such that the casing is supported relative to the mounting surface by the support arrangement while substantially preventing heat transfer from the casing to the gearbox via the support arrangement.

23. Mounting apparatus according to claim 22, wherein the support arrangement includes a collar that is coupled to the wall of the gearbox around the shaft opening and a first end of the casing proximate to the gearbox in use, the plurality of support members extending from the collar, such that the support members are coupled to the gearbox using the collar.

24. Mounting apparatus according to claim 23, wherein the collar is a ring that surrounds the shaft opening and the first end of the casing and is offset radially from the casing.

25. Mounting apparatus according to claim 22, wherein the integrally geared turbine is a supercritical carbon dioxide (sCO2) turbine.
